(19) United States
(12) Patent Application Publication
(10) Pub. No.: US 2016/0156105 A1
(43) Pub. Date: Jun. 2, 2016

(54) COMBINED APERTURE AND MANIFOLD APPLICABLE TO PROBE FED OR CAPACITIVELY COUPLED RADIATING ELEMENTS

(71) Applicant: Michael J. Buckley, LLC, Marion, IA (US)

(72) Inventor: Michael J. BUCKLEY, Marion, IA (US)

(21) Appl. No.: 14/956,819

(22) Filed: Dec. 2, 2015

Related U.S. Application Data
(60) Provisional application No. 62/086,493, filed on Dec. 2, 2014.

(51) Int. Cl. H01Q 13/10

(52) U.S. Cl. CPC H01Q 13/106

(57) ABSTRACT

A combined aperture and manifold is provided for use in higher order floquet mode scattering apertures. The combined aperture and manifold includes an aperture layer and a plurality of radiating elements provided in the aperture layer. The plurality of radiating elements are adapted to transmit and receive electromagnetic energy. A microstrip line is provided in the aperture layer to function as the manifold. The manifold delivers energy to and from the module layer. A probe is disposed within an aperture probe via of the aperture layer, the probe adapted to conduct electromagnetic energy to the plurality of radiating elements. The microstrip line defines a boundary of the aperture layer.

### CROSS-REFERENCE TO RELATED APPLICATIONS

This application claims priority under 35 U.S.C. §119 to U.S. Provisional Patent Application No. 62/086,493, filed on Dec. 2, 2014, which is incorporated by reference herein in its entirety.

### BACKGROUND

Existing active electronically scanned array (AESA) technology includes three layers: an aperture layer, a manifold/feed layer, and a module layer. An AESA can receive and transmit electromagnetic energy (i.e., radio waves) and has traditionally been used in radar applications. AESA technology has also been explored for use in communications applications, particularly internet access in underdeveloped areas of the world.

The aperture layer in existing AESA systems includes many individual radiating elements. Each radiating element transmits and receives energy. The combined energy radiated from the radiating elements can be steered to, for example, track an airplane in radar applications or access the internet from a low earth orbiting satellite in communications applications. When the aperture layer is in a receive mode, the aperture layer delivers energy to the module layer. The module layer amplifies the energy and then delivers the energy to the manifold/feed layer for further processing. When the aperture layer is in a transmit mode, the modules deliver energy to the aperture layer. The aperture layer converts the energy to radio waves and directs the energy to its target through free space, for example, directing the energy to an airplane (radar applications) or to a low earth orbiting satellite (internet applications).

### BRIEF SUMMARY OF THE INVENTION

In an embodiment, the invention provides a combined aperture and manifold for use in higher order floquet mode scattering apertures. The combined aperture and manifold includes an aperture layer and a plurality of radiating elements provided in the aperture layer. The plurality of radiating elements are adapted to transmit and receive electromagnetic energy. A microstrip line is provided in the aperture layer. A probe is disposed within an aperture probe via of the aperture layer, the probe adapted to conduct electromagnetic energy to the plurality of radiating elements. The microstrip line defines a boundary of the aperture layer.

In another embodiment, the invention provides an active electronically scanned array that includes a combined aperture and manifold layer. A plurality of radiating elements are provided in the combined aperture and manifold layer, the plurality of radiating elements adapted to transmit and receive electromagnetic energy. A microstrip line is provided in the combined aperture and manifold layer. A module layer is provided that generates electromagnetic energy. A probe is disposed within an aperture probe via of the combined aperture and manifold layer, the probe adapted to conduct electromagnetic energy from the manifold layer to the plurality of radiating elements. The microstrip line defines a boundary between the combined aperture and manifold layer and the module layer.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a cross-sectional view of an existing AESA system;

FIG. 2 is a cross-sectional view of an exemplary stripline;

FIG. 3 is a top down view of an exemplary stripline;

FIG. 4 is a cross-sectional view of an existing AESA system;

FIG. 5 is a cross-sectional view of an exemplary AESA system, according to an embodiment;

FIG. 6 is a cross-sectional view of an exemplary microstrip;

FIG. 7 is a top down view of an exemplary microstrip;

FIG. 8 is a cross-sectional view of an exemplary probe fed AESA system, according to an embodiment;

FIG. 9 is a cross-sectional view of an exemplary capacitively coupled AESA system, according to an embodiment;

FIG. 10A is top view of a manifold;

FIG. 10B is an enlarged view of part of the manifold shown in FIG. 10A;

FIG. 11 shows three views of a unit cell of a probe fed aperture;

FIG. 12 shows aperture performance of the probe fed aperture shown in FIG. 11;

FIG. 13 shows co-polar and cross-polar coupling for the probe coupled aperture shown in FIG. 11;

FIG. 14 is a cross-sectional view of a linearly polarized probe fed radiating element;

FIG. 15A is a top view of a combined feed-manifold layer;

FIG. 15B is a top view of a higher order Floquet mode scattering layer for a radiating element;

FIG. 16 shows performance of a Wilkinson power divider of the manifold shown in FIG. 10A and 10B;

FIG. 17 shows a cross-sectional view and an enlarged cross-sectional view of a capacitively coupled aperture;

FIG. 18A is a top view of a unit cell of a higher order Floquet mode scattering layer;

FIG. 18B is a top view of a unit cell of a combined feed and manifold layer;

FIG. 19 is a cross-sectional view of a radiating element;

FIG. 20 is a top view of a ground plane layer of a radiating element;

FIG. 21 is a top view of a lower metallization layer of a radiating element;

FIG. 22 is a top view of a mid-metallization layer of a radiating element; and

FIG. 23 is a top view of an upper metallization layer of a radiating element.

### DETAILED DESCRIPTION OF THE PREFERRED EMBODIMENTS

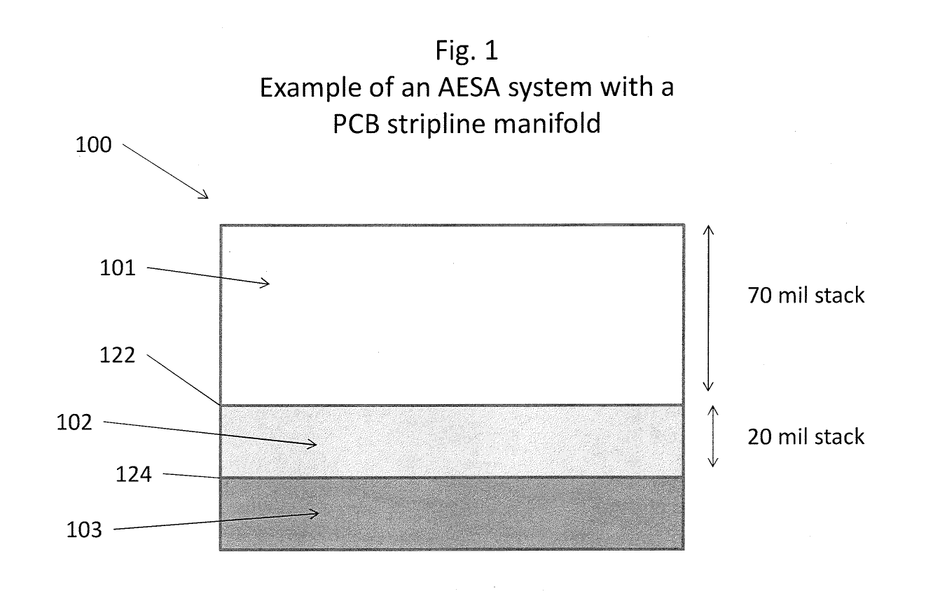

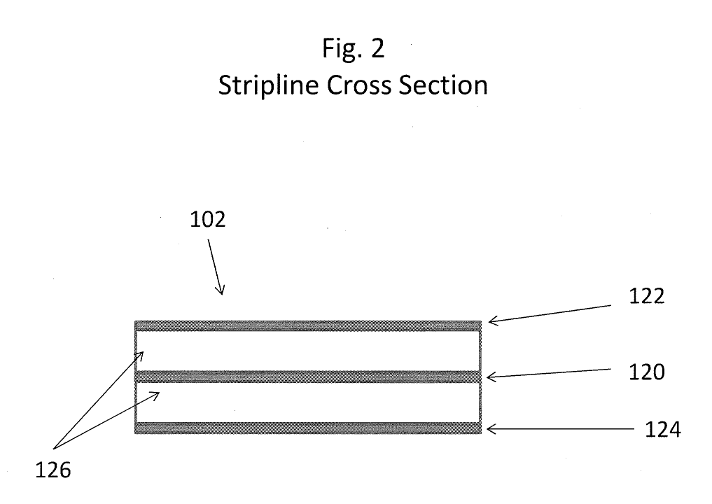

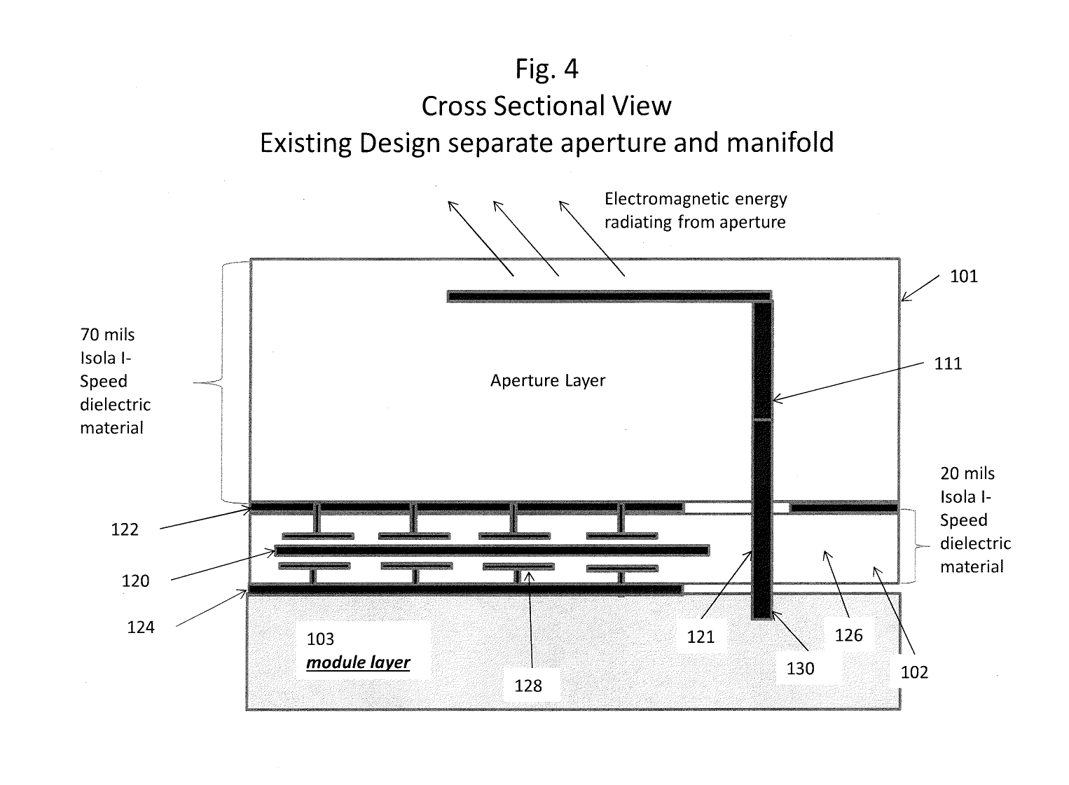

According to an existing aperture and manifold design shown in FIG. 1, a three part structure 100 is provided. An aperture layer 101 that radiates electromagnetic energy to a target is connected to a separate manifold/feed layer 102 that distributes electromagnetic energy. With additional reference to FIG. 4, electromagnetic energy from modules in a module layer 103 is provided to the aperture layer 101 by way of a probe 130 that is formed in a manifold probe via 121 in the manifold layer 102 and an aperture probe via 111 in the aperture layer 101. With reference to FIG. 2, the manifold layer 102 is formed as a stripline. Manifold layer 102 includes a bottom ground plane 124 and a top ground plane 122. Disposed between the bottom ground plane 124 and the top ground plane 122 is a center conductor 120, which distributes the electromagnetic energy. The bottom ground plane 124, the top ground plane 122, and the center conductor 120 are formed of a printed circuit board (PCB) metal material. A dielectric material 126 is provided in the manifold layer 102 to separate the PCB metal of the top ground plane 122, the bottom ground plane 124, and the center conductor 120. The top ground plane 122 forms a boundary between the manifold layer 102 and the aperture layer 101.

The aperture layer 101 could have a thickness of, for example, 70 mils, and the manifold layer 102 could have a thickness of 20 mils, as shown in FIGS. 1 and 4. The top ground plane 122 and the bottom ground plane 124 provide a discrete layer that can easily be integrated with modules in the module layer 103 and radiating elements in a printed circuit board architecture. A problem, however, in such a stripline manifold is that mode suppression vias 128 must be used to suppress resonances in the manifold layer 102. In this regard, at discrete frequencies the manifold 102 acts like a resonant cavity, and at these frequencies, the AESA fails unless grounding vias 128 are used.

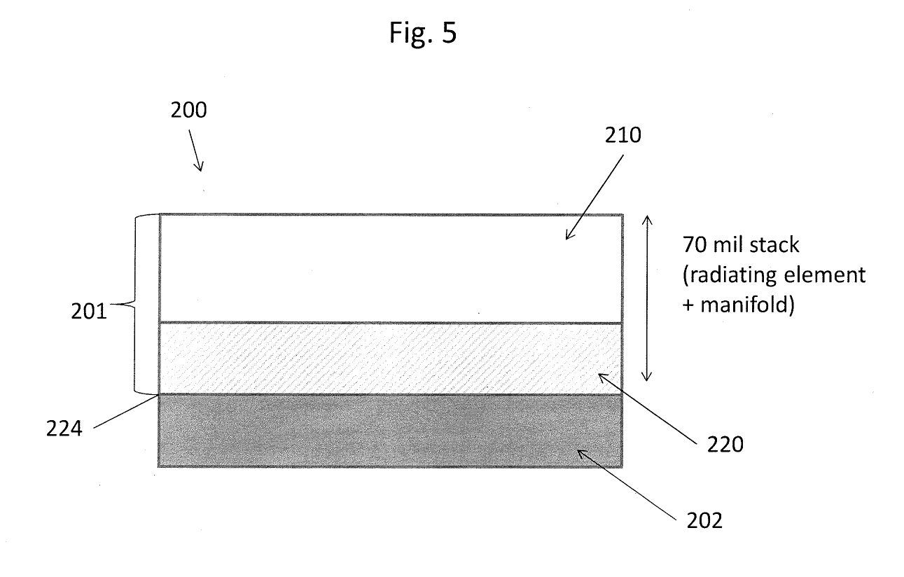

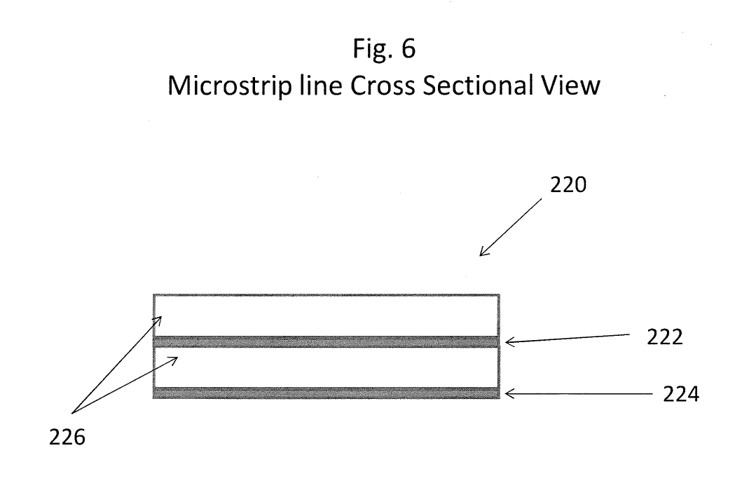

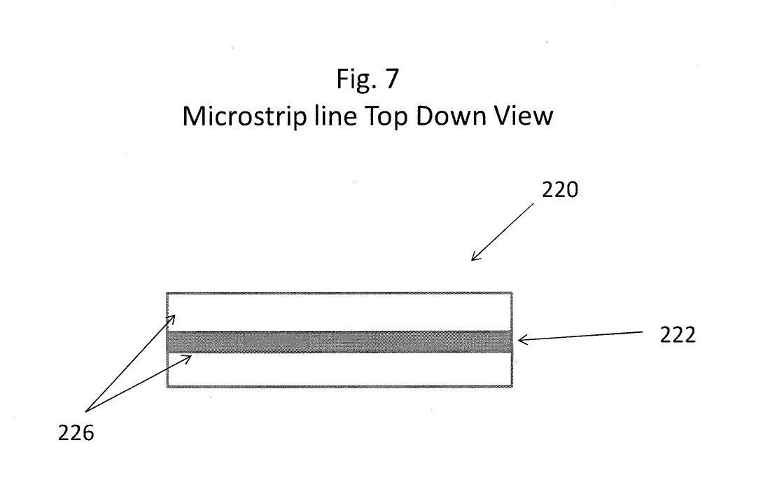

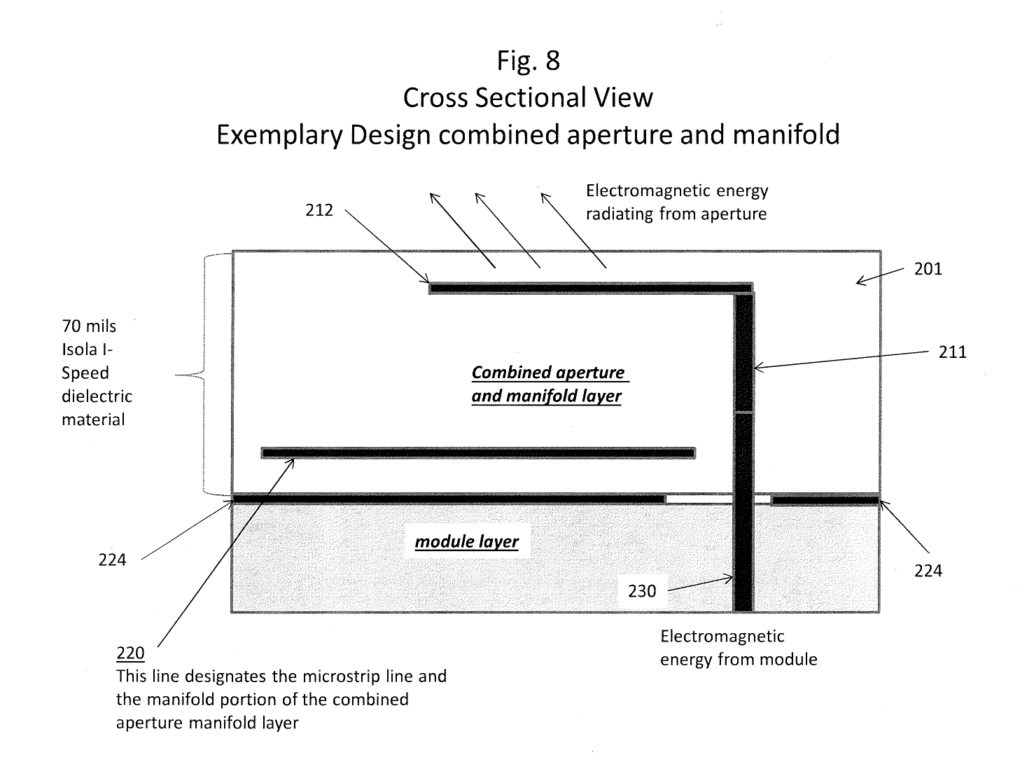

According to an embodiment shown in FIG. 5, an AESA system 200 is formed of a two layer structure. The AESA system 200 includes a module layer 202 formed together with an integrated aperture layer 201. The integrated aperture layer 201 incorporates a radiating element portion 210 together with a manifold/feed element portion 220 into a single layer 201. The integrated aperture layer 201 does not utilize the stripline manifold shown in FIG. 2, but instead includes a microstrip line 220 as the manifold (shown in FIG. 6). The microstrip line 220 consists of a center conductor 222 and a bottom ground plane 224 serving as a bottom boundary of the microstrip line 220. No top ground plane is provided. The center conductor 222 and the bottom ground plane 224, which are formed of a PCB metal, are separated by a dielectric material 226. For example, the dielectric material 226 may be an FR-4 material, such as Isola I-Speed. With additional reference to FIG. 8, line 220 represents the microstrip line and the manifold portion of the combined aperture manifold layer (integrated aperture layer 201).

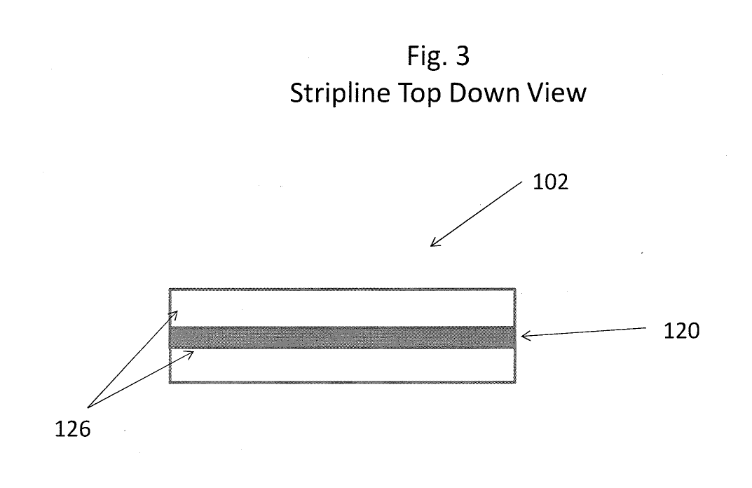

Existing AESA systems, such as those shown in FIGS. 1-4, cannot use discrete microstrip line manifolds because a microstrip line manifold does not provide a discrete layer that can be easily integrated with the modules and the radiating elements in a PCB architecture. In this regard, whereas the stripline manifold 102, as shown in FIG. 2, is bounded by a top ground plane 122 and a bottom ground plane 124, the microstrip line 220, as shown in FIG. 6, is only bounded by a bottom ground plane 224. Implementing a microstrip line manifold instead of a stripline manifold presents substantial difficulties, including for example, coupling issues between the aperture ground plane, the microstrip line manifold, and the microstrip ground plane. In the microstrip line 220 used in the AESA system 200, no boundary exists that will separate the manifold portion 220 from the radiating element portion 210. The microstrip bottom ground plane 224 separates the manifold portion 220 from the module layer 202.

Because the microstrip line manifold is not bounded by a top ground plane, it can be combined with the aperture layer into a single integrated unit. This is in contrast to current state of the art separate manifold and aperture layers separated by a ground plane. In addition, because the microstrip line 220 used in the AESA system 200 is not bounded on its top by a ground plane (i.e., the microstrip line 220 is not a closed structure), the microstrip line 220 does not resonate. Accordingly, grounding vias to address resonance are not required in the microstrip line 220 included in the AESA system 200.

With reference to FIGS. 5 and 8, the integrated aperture layer 201 can have a thickness of 70 mils. Electromagnetic energy from modules in the module layer 202 is provided to radiating elements 212 of the integrated aperture layer 201 by way of a probe 230 that is formed in an integrated aperture probe via 211 in the integrated aperture layer 201.

Combining the feed and manifold portion 220 with the aperture portion 210 into a single integrated aperture layer 201 is preferably achieved by using a low cost high dielectric constant FR-4 material. In addition, a probe fed radiating element rather than an aperture coupled radiating element is preferably used. In this regard, an aperture coupled radiating element often requires a large amount of physical space to be combined with the radiating element portion.

The cost of manufacturing commercial AESA systems is primarily driven by the cost of PCB material. For example, existing AESA systems typically use low dielectric constant materials such as foams or Rogers 5880, which do not allow for FR-4 manufacturing techniques. Alternatively, existing systems may use higher dielectric constant Teflon based materials such as Rogers 3003 or Rogers 5880 LZ, which allow for FR-4 techniques but are considerably more expensive to process. In contrast, according to embodiments, a low-cost FR-4 type of material such as Isola I-Speed may be used. In addition, according to the example shown in FIG. 1, out of a total of a 90 mil PCB stack (manifold layer 102 & radiating element layer 101), 20 mils is occupied by the manifold 102. According to embodiments, the manifold layer 102 may be eliminated, thereby reducing the PCB material costs by approximately 28%. Generally, combining the manifold layer with the stripline layer, according to embodiments, advantageously reduces the amount of PCB material required by 20-35%. The cost of manufacture is reduced further because ground vias are not required to address resonance as the system 200 is not bounded on its top and bottom by a ground plane. The use of a probe coupled radiating element as opposed to an aperture coupled radiating element further reduces the cost of the AESA system, according to embodiments. In this regard, an aperture coupled radiating element would require more lamination steps in production than a probe coupled radiating element. Reducing the number of lamination steps in production could potentially reduce costs by approximately 30%.

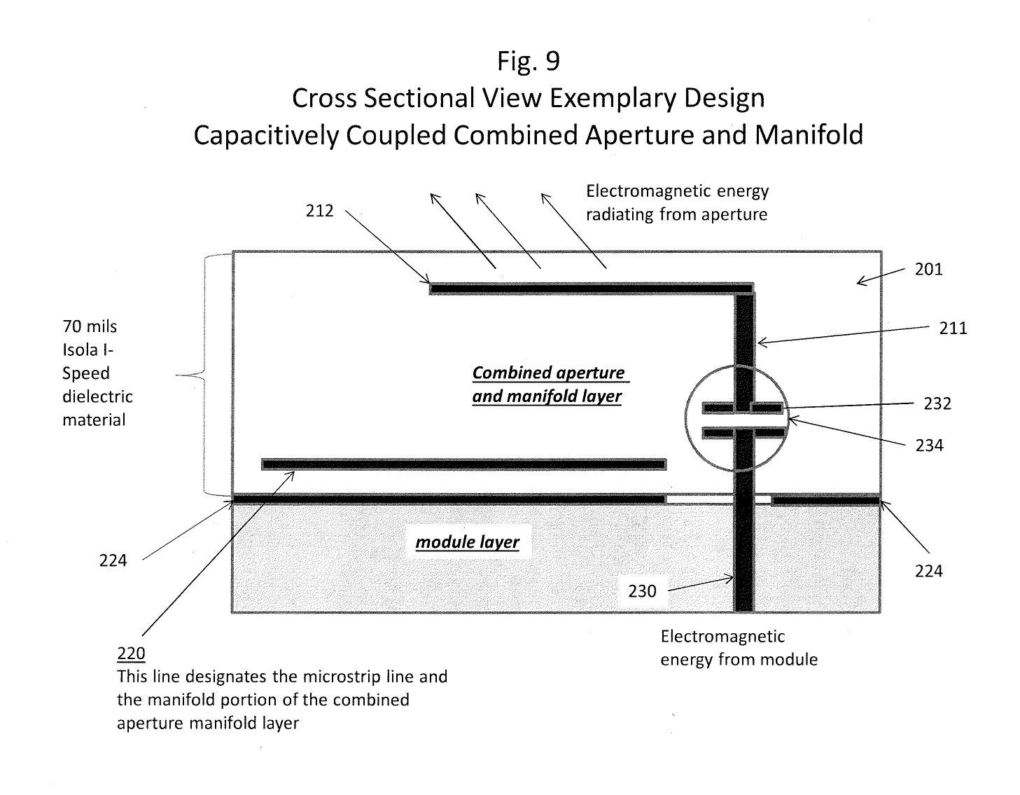

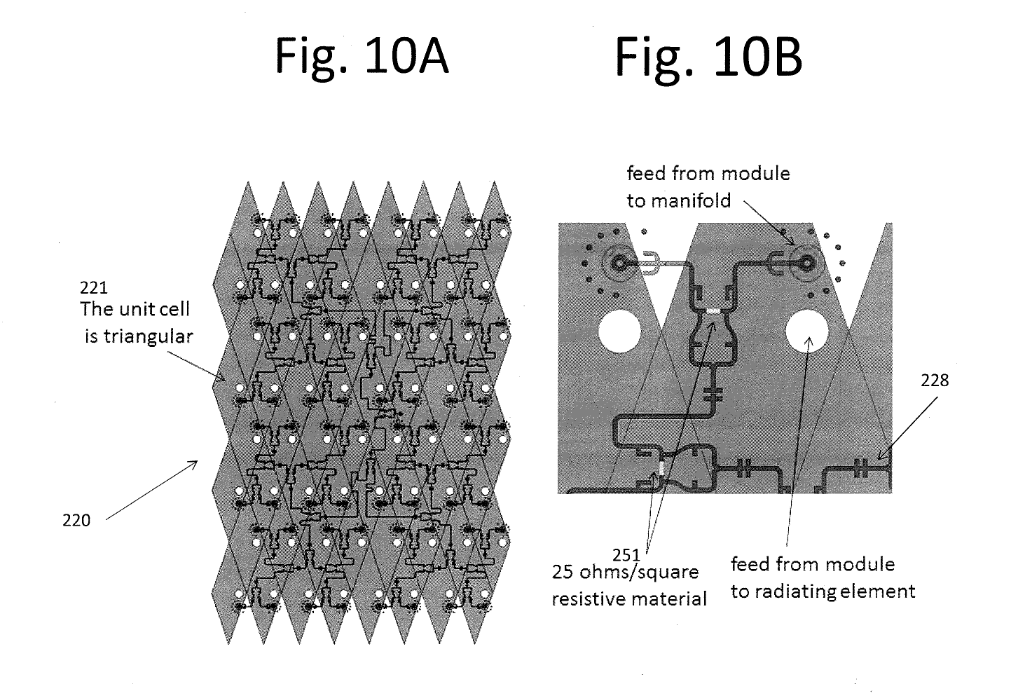

The combined aperture and manifold may be applied to linearly polarized AESA systems or dual polarized AESA systems. The dual polarized AESA systems may include, but are not limited to: circular polarization, elliptical polarization, and slant linear polarization. The apertures that this combined aperture and manifold may be applied to include patch apertures and higher order Floquet mode scattering apertures. The microstrip manifold may be reactive, that is, printed circuit board metal with no resistive material or it may be non-reactive printed circuit board metal with resister materials such as OhmegaPly or Ticer resistive material (see FIGS. 10A and 10B). In addition, the microstrip manifold may alternatively use surface resistive devices (e.g., surface mount resistors) in order to achieve a non-reactive manifold. The combined aperture and manifold may be applied to capacitively coupled linearly polarized AESA systems or dual polarized AESA systems. An example of a capacitively coupled AESA system with a combined aperture and manifold is shown in FIG. 9. Capacitively coupled apertures use electromagnetic coupling to transmit the signal to the aperture from the module layer, rather than a direct DC connection provided by a probe. In some cases, capacitively coupled apertures require fewer lamination steps, further reducing AESA system cost. According to the system shown in FIG. 9, a capacitively coupled region 234 includes a capacitor 232 that is provided along the probe 230. The capacitively coupled region 234 is provided within the integrated aperture layer 201 of the AESA system.

With reference to FIG. 10A, the manifold portion 220 includes a plurality of unit cells 221. The exemplary manifold 220 shown in FIG. 10A includes 64 triangular unit cells 221 (i.e., a 64 element manifold). Referring to FIG. 10B, an enlarged view of part of the manifold 220 shown in FIG. 10A is provided. According to the manifold 220 shown in FIG. 10B, a resistive material 251 is provided along PCB traces 228 that are provided in the manifold 220. Manifolds 220 function as transmission line structures with resistive material 251 being provided to prevent the transmission line from “ringing” or becoming unbalanced. The resistive material 251 is shown as having a resistance of 25 ohms/square, but other suitable resistances known to those of skill in the art may be used. Further, combining the feed layer with the manifold layer as shown in FIGS. 10A and 10B also reduces AESA cost and manufacturing complexity.

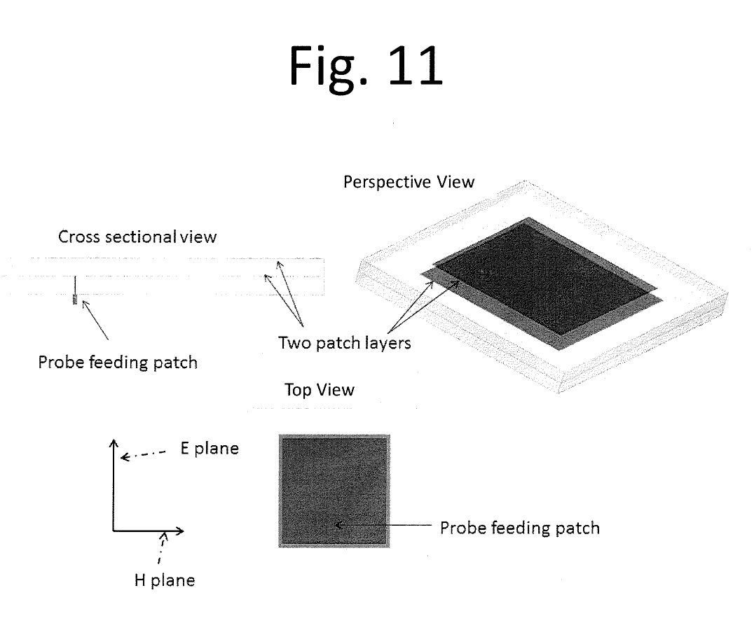

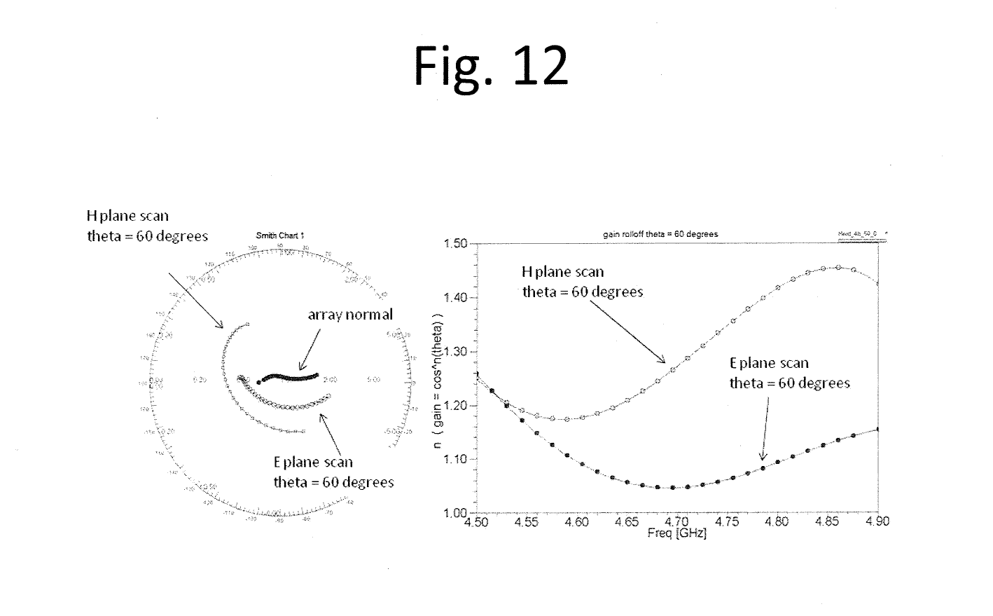

Probe fed and capacitively coupled apertures are further described below. A probe fed aperture is shown in FIG. 11, which provides three views of a unit cell of a probe fed aperture. The aperture may consist of two 60 mil layers of a Rogers 5870 material, with each layer having a patch. The position of the probe is symmetric with respect to the E plane. For electromagnetic energy to couple from the probe to the patch, the position of the probe must be asymmetric with respect to the H plane. On account of the asymmetric position of the probe, a significant cross polar coupling for wide angle H plane scan results. The small area of the probe feed allows the manifold and feed layers to be combined. Eliminating a separate stripline layer reduces material costs and avoids a series of back drill and fill operations. A lamination step is eliminated, lowering processing costs, and improving via reliability over temperature cycles. A conventional probe fed aperture has important issues. The probe fed aperture unit cell consists of a Rogers 5870 substrate with two printed circuit board metal patches. A low dielectric constant substrate such as Rogers 5870 is necessary for an aperture using patches because the patches scatter into lower order Floquet modes. The lower order Floquet modes must be relatively constant for all scan angles of interest and hence the dielectric substrate constant must be low and the unit cell must be relatively small. The small unit cell size adversely impacts AESA system cost. The coefficient of thermal expansion of Rogers 5870 is anisotropic. Repeated temperature cycling of the probe and vias in the manifold raises concerns about via integrity. The aperture performance as a function of frequency at array normal and 60 degree scan in the E and H planes is shown in FIG. 12. Even with a low dielectric constant substrate, the gain roll off in the wide H plane scan is problematic for patch radiating elements.

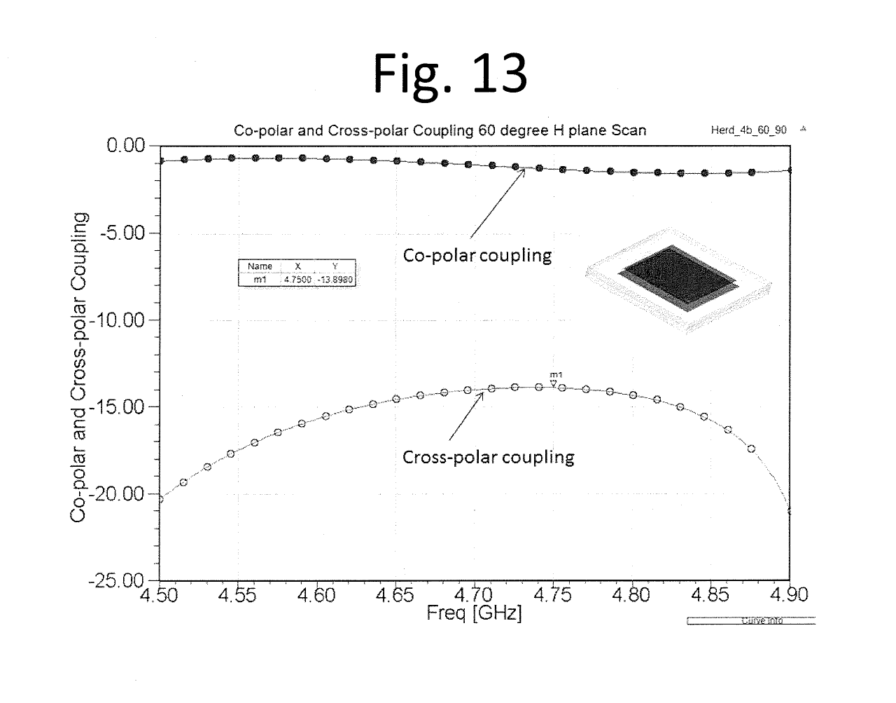

An additional problem for the probe fed patch is cross polar coupling at wide H plane scan angles. FIG. 13 is a plot of the co-polar and cross-polar coupling at 60 degree H plane scan for the probe fed aperture. The cross-polar coupling is high because the probe is in an asymmetric position with respect to the scan plane and patches are used to couple energy from the probe to free space. For H plane scan angles, the probe fed patch couples to both the co-polar and cross-polar modes. The co-polar and the cross-polar modes are necessary to enforce the boundary condition at the surface of the (almost square) metal patch. For E plane scan, the probe fed patch configuration is symmetric with respect to the scan plane and hence no coupling to the cross-polar mode is possible.

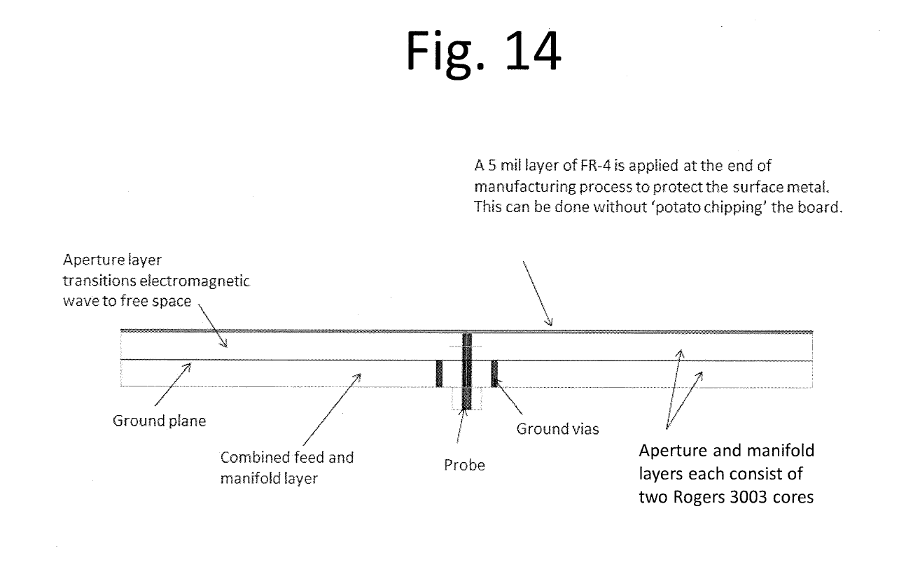

A cross-sectional view of a probe fed linearly polarized aperture is shown in FIG. 14. The radiating element is probe fed to maximize potential manifold area. The board is balanced with the aperture and manifold each made of two Rogers 3003 15 mil cores. The feed probe extends through both the entire aperture and manifold layers, thereby eliminating a back drill operation. A 5 mil layer of FR-4 is applied after the Rogers 3003 processing, thereby protecting the top metal layer. This layer is attached using FR-4 processing techniques and does not alter the integrity of the board. The requirements for the linearly polarized probe fed aperture are: 19-21 GHz frequency band, linearly polarized with no H plane scan cross-coupling problems, scan to 45 degrees in the E plane, scan to 10 degrees in the H plane, and have the largest possible unit cell size. In order to maximize unit cell size, the triangular grid array is not an equilateral triangular grid. This takes advantage of the non-uniform theta scan requirements. In order for the aperture to be relatively inexpensive and easy to manufacture, the radiating element uses Rogers 3003, the board is balanced, and the manifold and feed layers are combined. Combining the manifold and feed layers eliminates a lamination step. The fewer the number of lamination steps, the better the via integrity is over repeated temperature cycles. The high frequency of operation precludes the use of Rogers 4003 throughout the aperture.

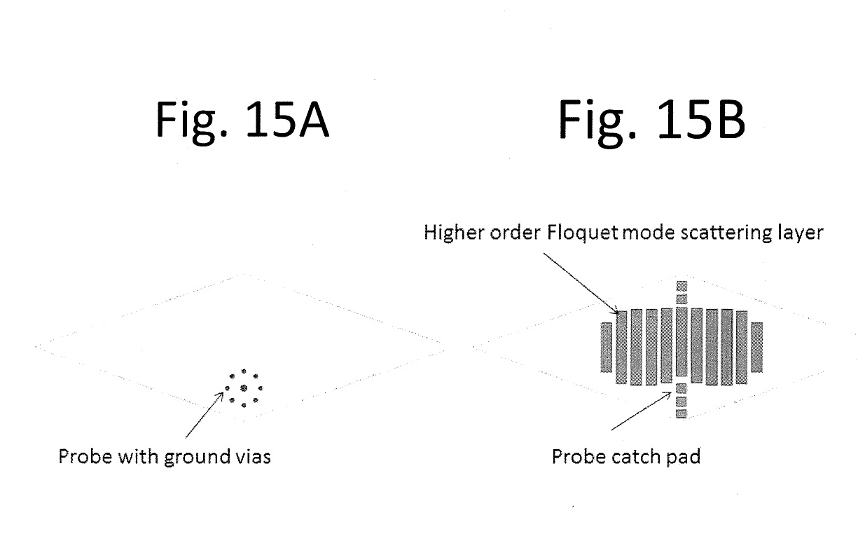

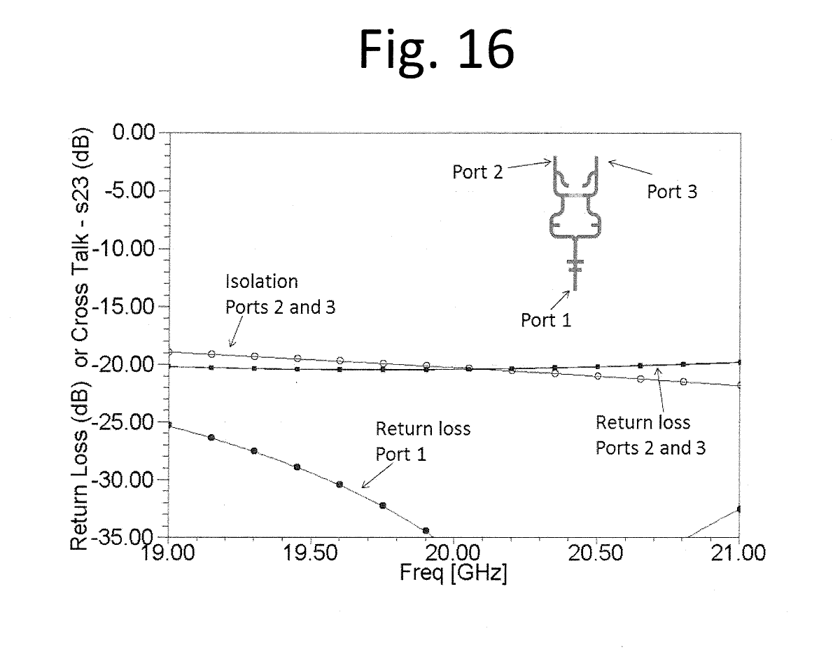

FIG. 15A is a top down view of the combined manifold and feed layer, and FIG. 15B is a top down view of a higher order Floquet mode scattering layer for the 19-21 GHz radiating element. A higher order Floquet mode scattering layer is used instead of a patch layer shown in FIG. 11. The higher order Floquet mode scattering layers replace the patches in a conventional probe fed aperture. The higher order Floquet mode scattering layers address H plane scan gain problem, the H plane scan polarization problem, and allows lower cost higher dielectric constant materials to be used. The feed to the radiating element is small enough to allow the manifold layer to be combined with the feed. An exemplary 64 element manifold/feed layer is shown in FIGS. 10A and 10B. The combined manifold/feed layer includes Wilkinson power dividers, an interconnect from the module to the aperture, and an interconnect from the module to the Wilkinson power divider manifold. The performance of an individual Wilkinson power divider used in FIG. 15 is shown in FIG. 16. Over the required 19-21 GHz frequency band, the Wilkinson power divider has good isolation and low return loss.

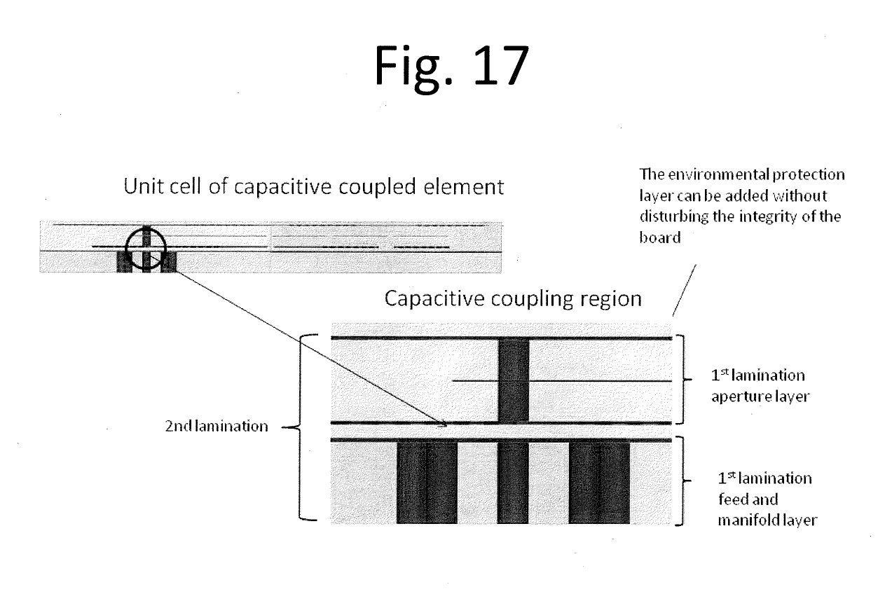

With reference to FIG. 17, a cross-sectional view of the unit cell of a capactively coupled aperture, and an enlarged cross-sectional view of the capacitively coupled region, are shown. The board shown in FIG. 17 is balanced and is comprised of layers made of low cost FR-4 laminates. The requirements for the linearly polarized capacitive coupled aperture are: 9.3-9.5 GHz frequency band, linearly polarized with no H plane scan cross-coupling problems, scan to 60 degrees for all phi cuts, and have the largest possible unit cell size. In order to maximize unit cell size, an equilateral triangular grid is used. In order for the aperture to be relatively inexpensive and easy to manufacture, the aperture uses low cost FR-4 laminate (dielectric constant 3.6). FR-4 laminate boards are manufactured using low cost techniques. The board is balanced, and the manifold and feed layers are combined. Balancing the board reduces manufacturing complexity. Combining the manifold and feed layers reduces material and manufacturing costs. Capacitive coupling further reduces cost and eliminates a through drill operation. Capacitive coupling is possible because of the narrow frequency band. In order to address the polarization and scan requirements, higher order Floquet mode scattering is used.

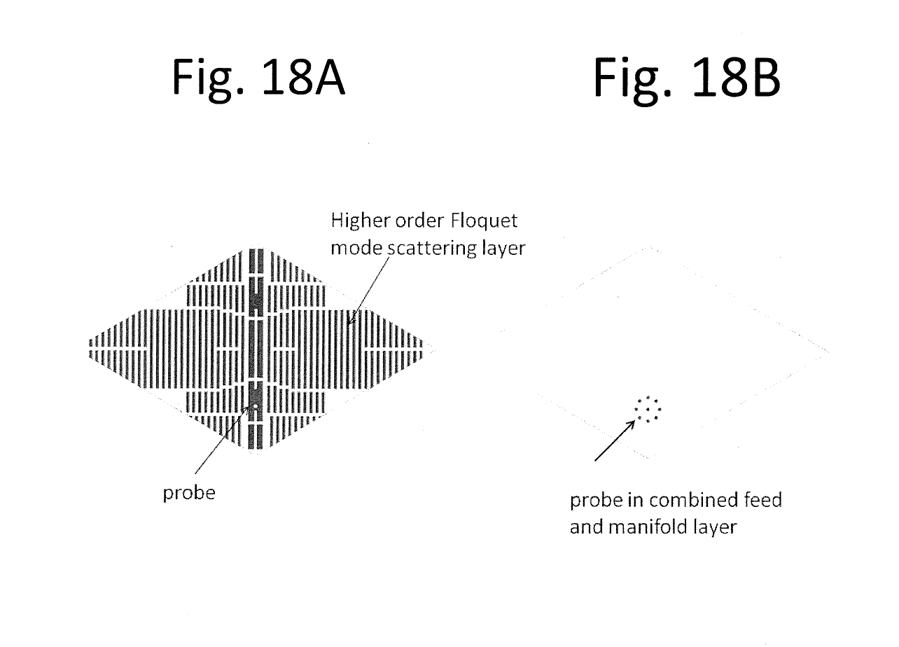

FIG. 18A is a top down view of the unit cell of the higher order Floquet mode scattering layer, and FIG. 18B is a top down view of the unit cell of the combined feed and manifold layer. The higher order Floquet mode scattering structure is configured to address the polarization and scan requirements. In addition, capacitive coupling, instead of stripline fed slot coupling, allows for the feed and manifold layers to be combined.

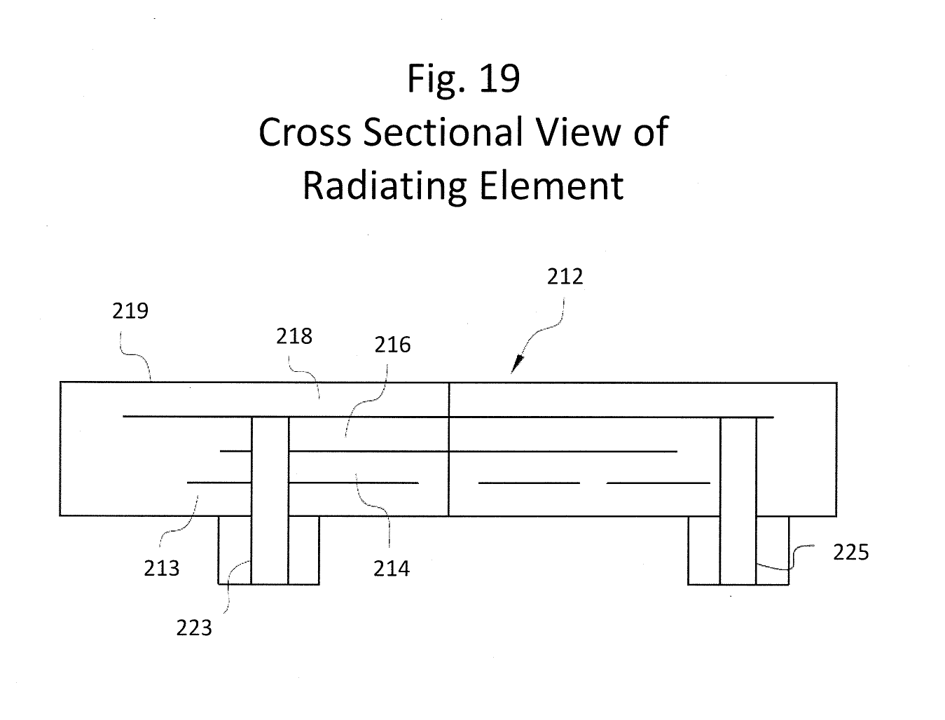

Exemplary radiating elements are now described with reference to FIGS. 19-23. Radiating elements 212, according to embodiments, may utilize higher order Floquet scattering and impedance matching to provide improved scan performance, wider bandwidth, and increased unit cell size. Each radiating element 212 is configured to generate two orthogonally polarized fields. With reference to FIG. 19, a cross-sectional side view of an exemplary radiating element 212 according to embodiments with two vertical probes is shown. The radiating element 212 has a number of PCB layers including a ground plane layer 213, a lower metallization layer 214, a mid-metallization layer 216, an upper metallization layer 218, and a radome layer 219. Two conductive probes 223 and 225 connect all metallized layers to the ground plane layer 213 and excite the lower metallization layer 214.

The substrate material of the radiating element 212 may be FR-4, having a dielectric constant of 3.7, and loss tangent of 0.008. In one embodiment, a unit cell size of the radiating element 212 is 0.275 λ² at 14.5 GHz. Radiating elements 212 may have scan performance less than −10 dB return loss out of 30° half conical scan angle for arbitrary phi angle (e.g., between 0° and 360°). In some embodiments, radiating element 212 may be configured to operate in a frequency range of 10.7 to 14.5 GHz with scan volume from 0° to 30° in theta over all phi angles.

The radome layer 219 may include a layer of FR-4 applied at the end of the manufacturing process to protect the underlying metal layers. The FR-4 may be applied without excessively warping (potato chipping) the radiating element 212.

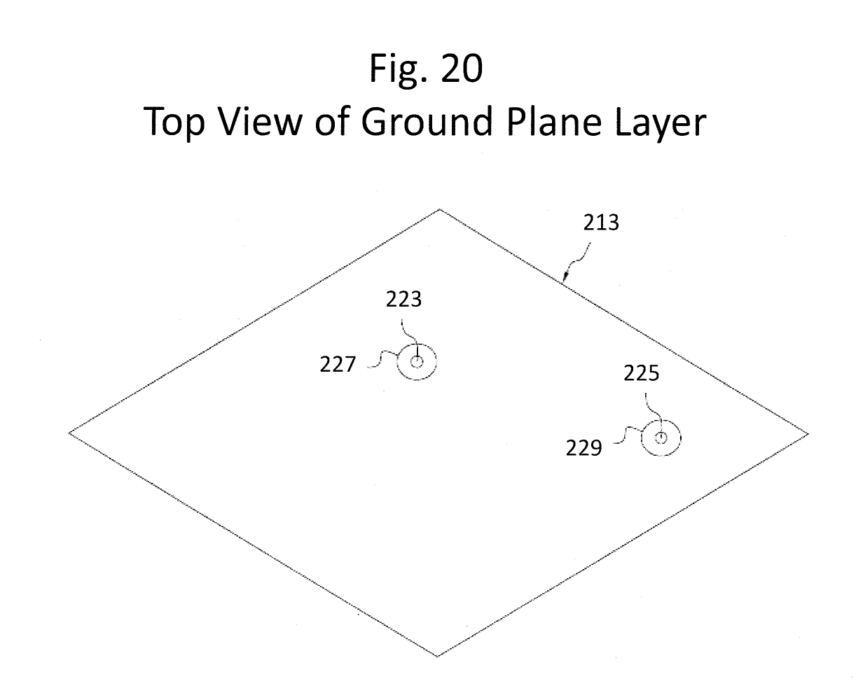

With reference to FIG. 20, a top view of the ground plane layer 213 of the radiating element 212 is shown. The ground plane layer 213 defines two openings 227 and 229 conforming to the conductive probes 223 and 225 connecting the metallized layers of the radiating element 212. The location of each vertical probe 223 and 225 may be determined in relation to the gain of the radiating element 212 with respect to the metallic layers and the final geometry of the High-Order Floquet scattering members and impedance-matching dipoles of the radiating element 212 as described below.

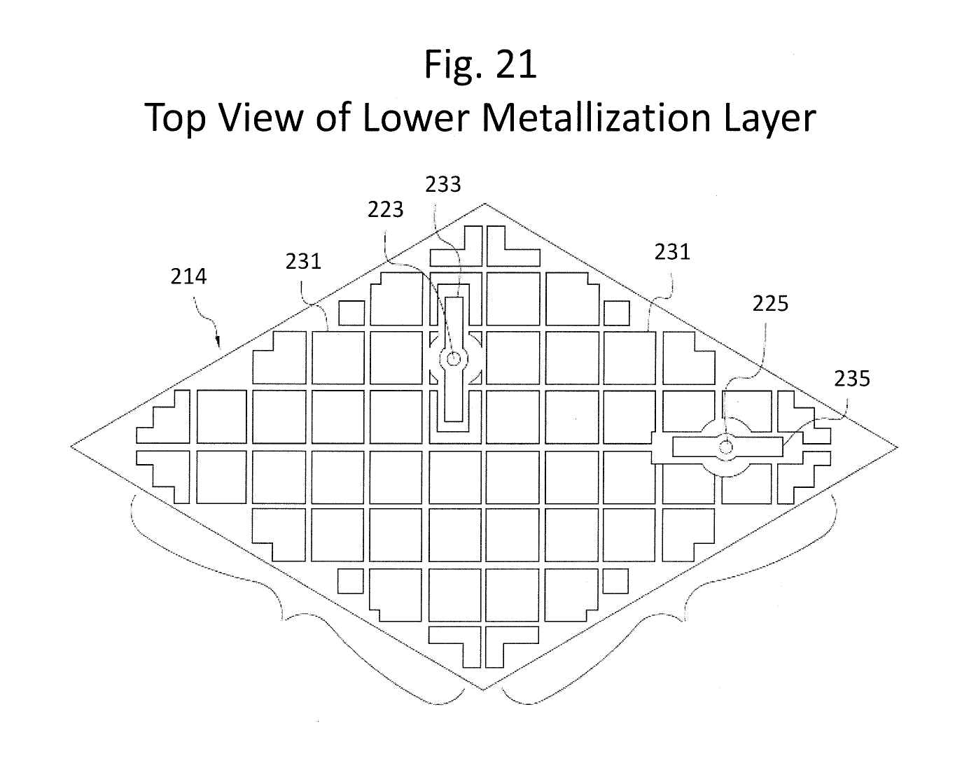

Referring to FIG. 21, a top view of the lower metallization layer 214 of the radiating element 212 according to embodiments is shown. The lower metallization layer 214 includes a plurality of Higher-Order Floquet (HOF) scattering members 231 and two impedance-matching dipoles 233 and 235 organized to tune the radiating element 212 in a particular frequency range.

The HOF scattering members 231 may be implemented as metallic or conductive strips, inclusions, or structures, embedded in, positioned on, or otherwise coupled with the substrate material of the lower metallization layer 214. The HOF scattering members 231 are desirably electrically-small (e.g., having sizes, lengths, or widths on the order of about 0.1 of an operational wavelength or spectrum for which the radiating element 212 is optimized or configured).

The impedance-matching dipoles 233 and 235 may be implemented as elongated (e.g., rectangular or strips) metallic or conductive structures, members, or inclusions embedded in, positioned on, or otherwise coupled with the substrate material of the lower metallization layer 214. The impedance-matching dipole 233 and the impedance-matching dipole 235 are oriented generally perpendicular or orthogonal relative to one another. The impedance-matching dipole 233 is coupled with the conductive probe 223, and the impedance-matching dipole 235 is coupled with the conductive probe 225.

The impedance-matching dipole 233 is oriented along an axis or direction as shown in FIG. 21. The impedance-matching dipole 233 and the HOF scattering members 231 may be configured, sized, spaced, and arranged so as to cooperate with one another to produce a signal having a known polarization. Similarly, the impedance-matching dipole 235 may be oriented along an axis generally perpendicular or substantially orthogonal relative to the axis of the impedance-matching dipole 233. Further, the impedance-matching dipole 235 and the HOF scattering members 231 may be configured, sized, spaced, and arranged so as to cooperate with one another to produce a signal having a known polarization which may be generally perpendicular or orthogonal relative to the polarization of the signal produced by the impedance-matching dipole 233.

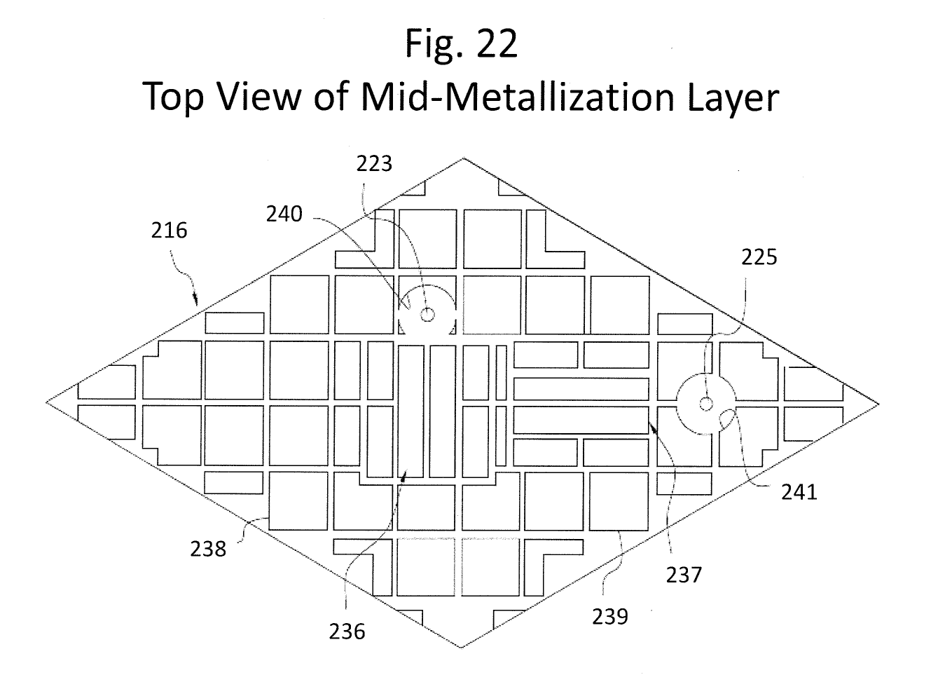

Referring to FIG. 22, a top view of the mid-metallization layer 216 of the radiating element 212 is shown. The mid-metallization layer 216 includes two sets of impedance-matching dipoles 236 and 237 and two sets of HOF scattering members 238 and 239, organized for a wide angle scan. The mid-metallization layer 216 may also include two vertical probe receiving areas 240 and 241 for receiving the conductive probes 223 and 225 therein, respectively. The conductive probe 223 is coupled with the probe receiving area 240 and the conductive probe 225 is coupled with the probe receiving area 241.

The HOF scattering members 238 and 239 may be implemented and may function similarly to the HOF scattering members 231.

The set of impedance-matching dipoles 236 is associated with the probe receiving area 240. The set of impedance-matching dipoles 236 may be excited by signals from the lower metallization layer 214 and is configured so as to cooperate with the set of HOF scattering members 238 and 239 to produce a signal which may have the same polarization as the signal produced by the impedance-matching dipole 233 and the HOF scattering members 231 of the lower metallization layer 214.

Similarly, the set of impedance-matching dipoles 237 is associated with the probe receiving area 241. The set of impedance-matching dipoles 237 may be excited by signals from the lower metallization layer 214 and is configured so as to cooperate with the set of HOF scattering members 238 and 239 to produce a signal which may have the same polarization as the signal produced by the impedance-matching dipole 235 and the HOF scattering members 231 of the lower metallization layer 214.

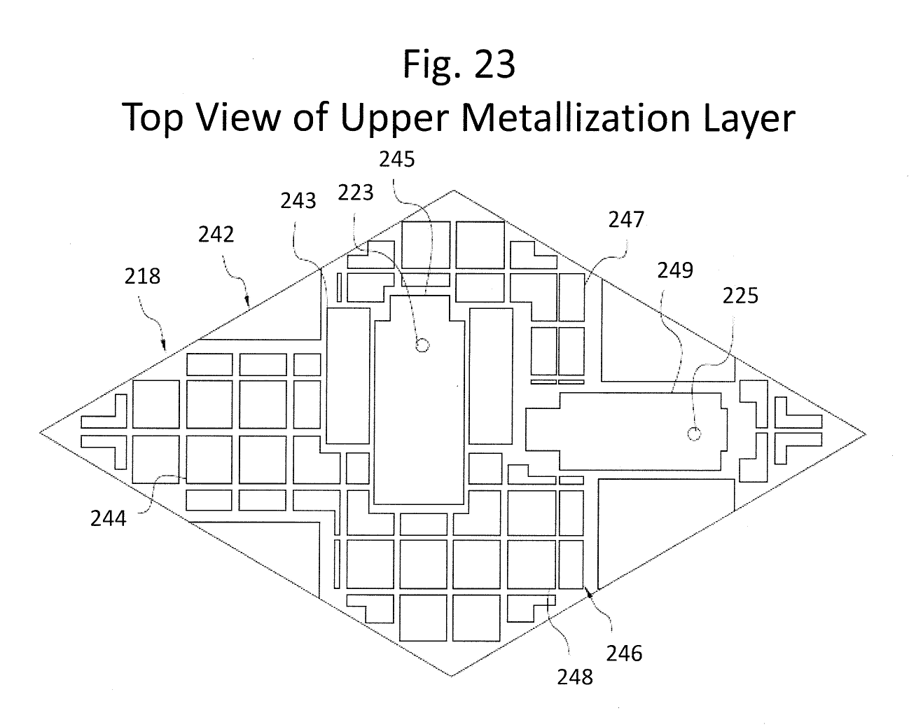

Referring to FIG. 23, a top view of the upper metallization layer 218 of the radiating element 212 is shown. The upper metallization layer 218 has an asymmetric cluster 242 including a plurality of impedance-matching dipoles 243 and a plurality of HOF scattering members 244, 246, 247, and 248 organized for a wide angle scan. The plurality of impedance matching dipoles 243 may be implemented and may function similarly to the impedance matching dipoles 236 and 237, and the plurality of HOF scattering members 244, 246, 247, and 248 may be implemented and may function substantially similarly to the HOF scattering members 231. An electrically-large impedance-matching dipole 245 (e.g., having a size greater than or equal to about 0.2 of the wavelength or spectrum for which the radiating element 212 is configured) is coupled with the conductive probe 223 and is associated with the asymmetric cluster 242. The electrically-large impedance-matching dipole 245 and the asymmetric cluster 242 may be excited by signals from the lower metallization layer 214, signals from the mid-metallization layer 216, and/or signals from the vertical probe 223 so that the electrically-large impedance-matching dipole 245 and the asymmetric cluster 242 cooperate with one another to produce a signal having the same polarization as the signal produced by the set of impedance-matching dipoles 236 and the sets of HOF scattering members 238 and 239 of the mid-metallization layer 216.

An electrically large impedance-matching dipole 249 (e.g., having a size greater than or equal to about 0.2 of the wavelength or spectrum for which the radiating element 212 is configured) is coupled with the conductive probe 225 and is associated with the asymmetric cluster 242. The electrically-large impedance-matching dipole 249 is oriented substantially orthogonally to the electrically-large impedance-matching dipole 245. The electrically-large impedance-matching dipole 249 and the asymmetric cluster 242 may be excited by signals from the lower metallization layer 214, signals from the mid-metallization layer 216, and/or signals from the vertical probe 225 so that the electrically-large impedance-matching dipole 249 and the asymmetric cluster 242 cooperate with one another to produce a signal having the same polarization as the signal produced by the set of impedance-matching dipoles 237 and the set of HOF scattering members 238 and 239 of the mid-metallization layer 216.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

What is claimed is:

1. A combined aperture and manifold for use in higher order floquet mode scattering apertures, the combined aperture and manifold comprising:
an aperture layer;
a plurality of radiating elements provided in the aperture layer, the plurality of radiating elements adapted to transmit and receive electromagnetic energy;
a microstrip line provided in the aperture layer; and
a probe disposed within an aperture probe via of the aperture layer, the probe adapted to conduct electromagnetic energy to the plurality of radiating elements,
wherein the microstrip line defines a boundary of the aperture layer.

2. The combined aperture and manifold of claim 1, wherein the microstrip line comprises
a center conductor,
a bottom ground plane, and
a dielectric material provided between the center conductor and the bottom ground plane,
wherein the center conductor is provided within the aperture layer and the bottom ground plane defines a bottom boundary of the aperture layer.

3. The combined aperture and manifold of claim 2, wherein the microstrip line further comprises a second dielectric material provided on a side of the center conductor opposite to the bottom ground plane.

4. The combined aperture and manifold of claim 3, wherein the second dielectric material is integrally formed with the aperture layer.

5. The combined aperture and manifold of claim 2, wherein the center conductor and the bottom ground plane are formed by metal.

6. The combined aperture and manifold of claim 1, further comprising:
a capacitively coupled region in the aperture layer, the capacitively coupled region including a capacitor provided along the probe.

7. An active electronically scanned array, comprising:
a combined aperture and manifold layer;
a plurality of radiating elements provided in the combined aperture and manifold layer, the plurality of radiating elements adapted to transmit and receive electromagnetic energy;
a microstrip line provided in the combined aperture and manifold layer;
a module layer that generates electromagnetic energy; and
a probe disposed within an aperture probe via of the combined aperture and manifold layer, the probe adapted to conduct electromagnetic energy from the manifold layer to the plurality of radiating elements,
wherein the microstrip line defines a boundary between the combined aperture and manifold layer and the module layer.

8. The active electronically scanned array of claim 7, wherein the microstrip line comprises
a center conductor,
a bottom ground plane, and
a dielectric material provided between the center conductor and the bottom ground plane,
wherein the center conductor is provided within the combined aperture and manifold layer and the bottom ground plane defines the boundary between the combined aperture and manifold layer and the module layer.

9. The active electronically scanned array of claim 8, wherein the microstrip line further comprises a second dielectric material provided on a side of the center conductor opposite to the bottom ground plane.

10. The active electronically scanned array of claim 9, wherein the second dielectric material is integrally formed with the combined aperture and manifold layer.

11. The active electronically scanned array of claim 8, wherein the center conductor and the bottom ground plane are formed by metal.

12. The active electronically scanned array of claim 7, further comprising:
a capacitively coupled region in the combined aperture and manifold layer, the capacitively coupled region including a capacitor provided along the probe.
